(19) United States
(12) Patent Application Publication
(10) Pub. No.: US 2015/0101458 A1
(43) Pub. Date: Apr. 16, 2015

(54) INTEGRATED FLOW DRILL SCREW WITH T-STUD

(71) Applicant: GM GLOBAL TECHNOLOGY OPERATIONS LLC, Detroit, MI (US)

(72) Inventors: Robert N. Saje, Shelby Township, MI (US); Marcel R. Cannon, Romeo, MI (US)

(73) Assignee: GM GLOBAL TECHNOLOGY OPERATIONS LLC, Detroit, MI (US)

(21) Appl. No.: 14/055,261

(22) Filed: Oct. 16, 2013

(51) Int. Cl. F16B 35/06; B25B 13/06

(52) U.S. Cl. CPC F16B 35/06; B25B 13/065
USPC 81/121.1; 411/401

(57) ABSTRACT

A flow drill screw includes a shank that extends along a rotation axis. The shank includes a flow drill portion and a thread portion. A head is attached to the shank at a second axial end of the shank, adjacent the thread portion. An attachment portion extends from the head and away from the thread portion, along the rotation axis. The attachment portion may include a T-stud connector, and is operable to attach a device thereto. A drive tool includes an open interior region for receiving the attachment portion therein. The head of the flow drill screw includes an external drive interface, disposed on an exterior surface of the head, radially about the rotation axis, which mates with an internal drive interface of the drive tool, to transmit torque therebetween.

### TECHNICAL FIELD

The invention generally relates to a flow drill screw.

### BACKGROUND

A flow drill screw is a fastener that includes a flow drill portion and a thread portion. The flow drill portion includes a conical tip for friction drilling through one or more sheet metal substrates. Friction drilling is a method of forming a hole in the sheet metal substrate by pushing material out of the way with the aid of heat from friction. The conical tip of the flow drill portion is pressed against the sheet metal substrate while rotating at a high rotational speed and while under a high pressure, thereby producing heat from friction which softens or plasticizes a portion of the sheet metal substrate near the flow drill portion. The flow drill portion then “sinks” or is pressed through the plasticized material, thereby forming a hole. The thread portion forms threads in the plasticized material of the sheet metal substrate as the flow drill screw is tightened against the sheet metal substrate. Flow drill screws may be used to attach one or more sheet metal substrates to a structural member.

Vehicles often include connectors, such as a T-stud connector, that are attached to a substrate. The T-stud connectors are used to attach a device, object or component to the substrate. For example, the connectors may be used to attach interior trim panels, acoustic panels, electrical harnesses, electrical modules, etc. to the substrate.

### SUMMARY

A flow drill screw includes a shank that extends along a rotation axis. The shank includes a flow drill portion and a thread portion. The flow drill portion is disposed at a first axial end of the shank. The thread portion is disposed at a second axial end of the shank. A head is attached to the shank at the second axial end of the shank, adjacent the thread portion. An attachment portion extends from the head and away from the thread portion, along the rotation axis. The attachment portion is operable to attach a device thereto.

An assembly system for attaching a flow drill screw to a sheet metal substrate is also provided. The assembly system includes a flow drill screw and a drive tool. The flow drill screw includes a shank that extends along a rotation axis, and includes a flow drill portion and a thread portion. The flow drill portion is disposed at a first axial end of the shank. The thread portion is disposed at a second axial end of the shank. A head is attached to the shank at the second axial end of the shank, adjacent the thread portion. An attachment portion extends from the head and away from the thread portion, along the rotation axis. The attachment portion is operable to attach a device thereto. The head includes an exterior surface disposed radially about the rotation axis. The exterior surface of the head defines an external drive interface. The drive tool is axially moveable along the rotation axis relative to the flow drill screw. The drive tool includes a radially inner surface disposed radially about the rotation axis. The radially inner surface of the drive tool defines an internal drive interface that corresponds to and is disposed in mating engagement with the external drive interface of the head for transmitting a torque therebetween.

A vehicle is also provided. The vehicle includes a structural member, and a flow drill screw disposed in threaded engagement with the structural member. The flow drill screw includes a shank that extends along a rotation axis, and includes a flow drill portion and a thread portion. The flow drill portion is disposed at a first axial end of the shank, and the thread portion is disposed at a second axial end of the shank. The thread portion is disposed in threaded engagement with the structural member. A head is attached to the shank at the second axial end of the shank, adjacent the thread portion. An attachment portion extends from the head, away from the thread portion, along the rotation axis. A device is attached to the attachment portion, such that the attachment portion of the flow drill screw attaches the device to the structural member.

Accordingly, the flow drill screw may be used to attach one sheet metal substrate to another, or to the structural member, and the attachment portion of the flow drill screw is used to attach the device to the sheet metal substrate. The flow drill screw incorporates or integrates a device connector, i.e., the attachment portion, thereby eliminating the need to install connectors separately from the flow drill screws.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of a flow drill screw.

FIG. 2 is a schematic cross sectional view of a drive tool engaging the flow drill screw.

FIG. 3 is a schematic perspective view of a structural member of a vehicle having a sheet metal substrate attached thereto by the flow drill screw, and showing a device attached to an attachment portion of the flow drill screw.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

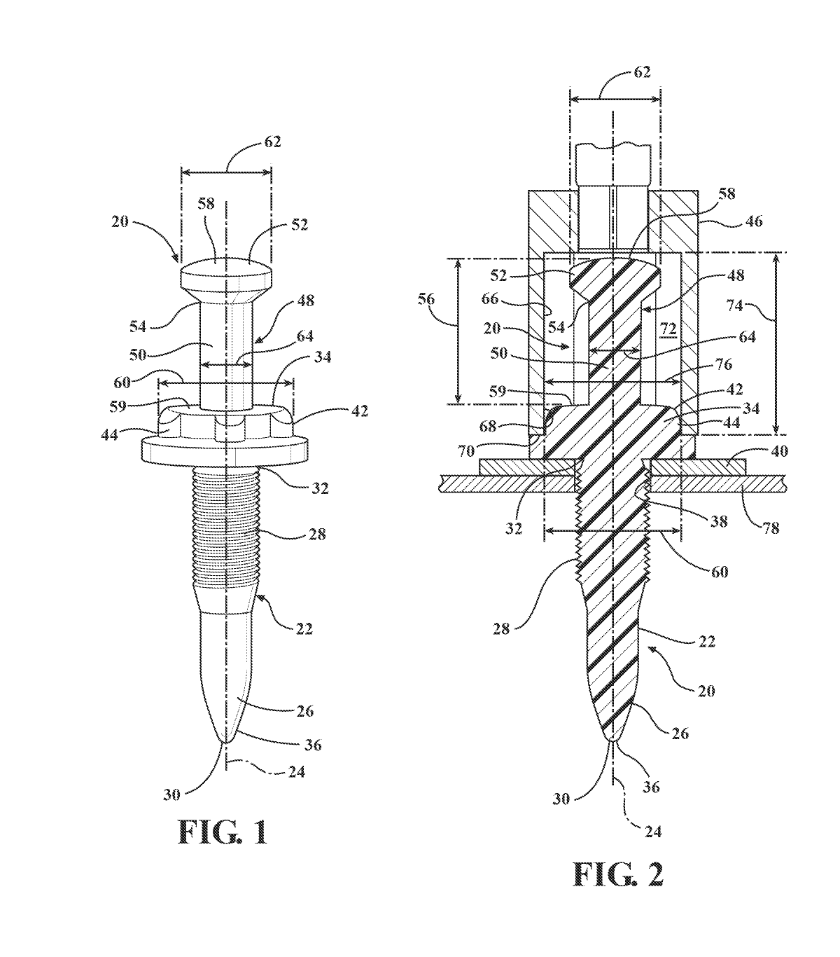

Referring to the Figures, wherein like numerals indicate like parts throughout the several views, a flow drill screw is generally shown at 20. Referring to FIGS. 1 and 2, the flow drill screw 20 includes a shank 22 that extends along a rotation axis 24. The shank 22 includes a flow drill portion 26 and a thread portion 28. The flow drill portion 26 is disposed at a first axial end 30 of the shank 22, and the thread portion 28 is disposed at a second axial end 32 of the shank 22. A head 34 is attached to the shank 22 at the second axial end 32 of the shank 22, adjacent the thread portion 28.

The flow drill portion 26 includes a conical tip 36 that is operable to form a hole 38 (shown in FIG. 2) in a sheet metal substrate 40 (shown in FIG. 2) by friction drilling. The conical tip 36, when pressed against the sheet metal substrate 40 at a high rotational speed and at a high pressure, generates friction which heats up the sheet metal substrate 40 and plasticizes the sheet metal substrate 40 in the region adjacent the conical tip 36. The conical tip 36 may then sink or be pressed through the plasticized portion of the sheet metal substrate 40, thereby displacing the plasticized material around the shank 22 to form the hole 38 in the sheet metal substrate 40. As the shank 22 is pressed through the hole 38, while rotating, the thread portion 28 forms threads in the plasticized material around the shank 22, thereby forming a threaded engagement between the sheet metal substrate 40 and the flow drill screw 20.

The head 34 includes an exterior surface 42 that is disposed radially about the rotation axis 24. The exterior surface 42 of the head 34 defines an external drive interface 44 for engaging a drive tool 46 (shown in FIG. 2). The external drive interface 44 is an engagement surface defined by an external radial surface of the head 34. Preferably, the external drive interface 44 defines a hexagonal drive, however, it should be appreciated that the external drive interface 44 may define some other manner of drive interface, such as but not limited to a square drive.

The flow drill screw 20 includes an attachment portion 48. The attachment portion 48 is operable to attach a device 82 thereto, i.e., to the flow drill screw 20. The attachment portion 48 extends from the head 34 along the rotation axis 24, and away from the thread portion 28. Preferably, and as shown in the Figures, the attachment portion 48 includes a T-stud. The T-stud includes a shaft portion 50 and a connector portion 52. The shaft portion 50 is attached to and extends from the head 34, along the rotation axis 24. The connector portion 52 is attached to a distal end 54 of the shaft portion 50. The connector portion 52 is axially spaced from the head 34 along the rotation axis 24 to define a maximum separation distance 56. The maximum separation distance 56 is the maximum distance between a distal surface 58 of the connector portion 52 and an upper surface 59 of the head 34. While the attachment portion 48 is shown and described as a T-stud connector, it should be appreciated that the attachment portion 48 may be configured as some other type and/or style of connector.

The exterior surface 42 of the head 34 defines a minimum head width 60 that is measured perpendicular to the rotation axis 24. The minimum head width 60 is the shortest distance across the head 34 perpendicular to the rotation axis 24. The attachment portion 48 defines a maximum connector width 62 that is also measured perpendicular to the rotation axis 24. The maximum connector width 62 is the longest distance across the attachment connector portion 52 perpendicular to the rotation axis 24. The maximum connector width 62 is less than the minimum head width 60. As such, the device 82 connector portion 52 is radially smaller than the head 34. As shown, the connector portion 52 of the T-stud connector defines the maximum connector width 62. The shaft of the T-stud connector defines a shaft diameter 64. The shaft diameter 64 is less than the maximum connector width 62.

Preferably, the shank 22, the head 34, and the attachment portion 48 are all integrally formed together as a single component, from a metal material. The flow drill portion 26 may be coated with a heat resistant material, such as but not limited to a cemented carbide.

An assembly system for attaching the flow drill screw 20 to the sheet metal substrate 40 includes the flow drill screw 20 described above, and the drive tool 46. Referring to FIG. 2, the drive tool 46 may include any type of tool for engaging, rotating the flow drill screw 20 about the rotation axis 24, and applying an axial pressure along the rotation axis 24. The drive tool 46 may commonly be referred to as a socket. However, it should be appreciated that the drive tool 46 may be configured in some other manner. The drive tool 46 is axially moveable along the rotation axis 24 relative to the flow drill screw 20. The drive tool 46 may be moved relative to the flow drill screw 20 in any manner. For example, the drive tool 46 may be attached to a robotic arm, which is moveable relative to the flow drill screw 20.

The drive tool 46 includes a radially inner surface 66 that is disposed radially about the rotation axis 24. The radially inner surface 66 of the drive tool 46 defines an internal drive interface 68 that corresponds to and may be disposed in mating engagement with the external drive interface 44 of the head 34 for transmitting a torque therebetween. As noted above, the external drive interface 44 of the head 34 and the internal drive interface 68 of the drive tool 46 each preferably include a hexagonal drive. However, whatever configuration of drive interface the drive tool 46 and the head 34 include, it should be appreciated that the external drive interface 44 of the head 34 and the internal drive interface 68 of the drive tool 46 correspond and mate with each other.

The drive tool 46 includes a distal end 70, and defines an open interior region 72. The open interior region 72 extends along the rotation axis 24, from the distal end 70, a depth 74 for receiving the attachment portion 48 therein. Accordingly, the depth 74 of the open interior region 72 is the length of open interior region 72 measured along the rotational axis. The depth 74 of the interior region is greater than the maximum separation distance 56 of the flow drill screw 20. As such, the open interior region 72 provides enough axial room for the attachment portion 48 when the drive tool 46 is engaged with the flow drill screw 20 during installation of the flow drill screw 20 into the sheet metal substrate 40.

The radially inner surface 66 of the drive tool 46 defines a minimum inner tool width 76 that is measured perpendicular to the rotation axis 24. The minimum inner tool width 76 is greater than the maximum connector width 62 and the minimum head width 60, so that the device 82 connector portion 52 may pass through and into the open interior region 72 of the drive tool 46.

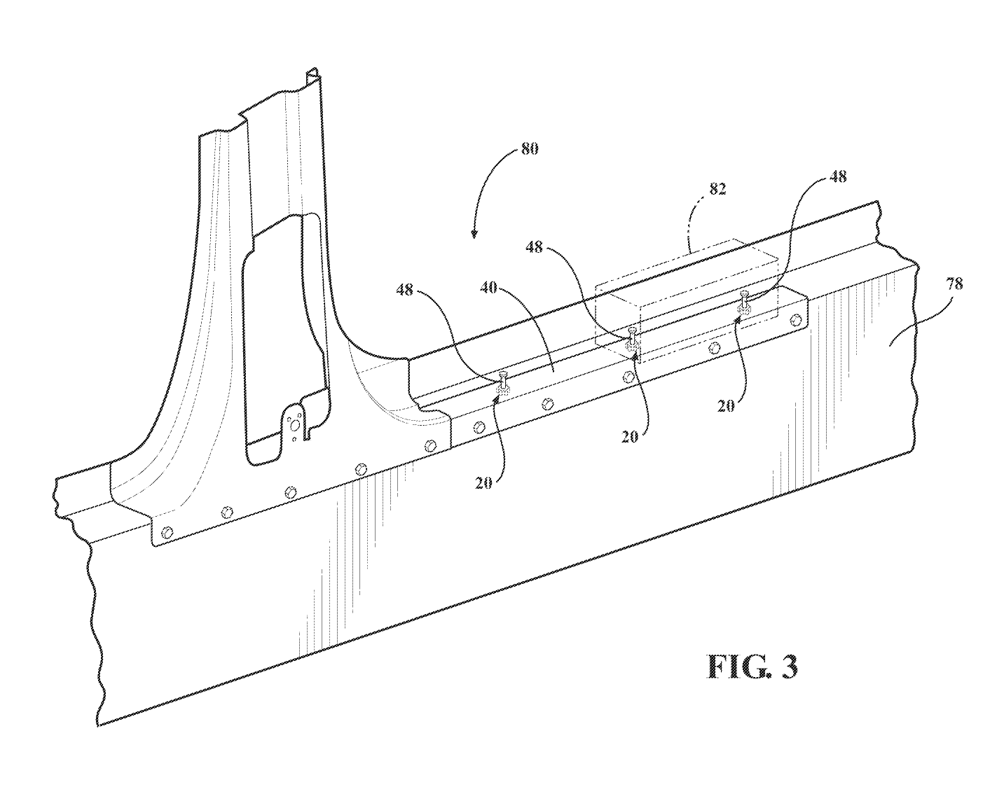

Referring to FIG. 3, the flow drill screw 20 may be used to attach the sheet metal substrate 40 to a structural member 78 of a vehicle 80. The flow drill portion 26 drills through the sheet metal substrate 40 and the structural member 78 as described above, while the thread portion 28 forms threads into the sheet metal substrate 40 and the structural member 78 as described above, thereby forming a threaded attachment with the sheet metal substrate 40 and the structural member 78 and attaching the sheet metal substrate 40 to the structural member 78. The device 82 may then be attached to the attachment portion 48 of the flow drill screw 20. The device 82 may include, but is not limited to one or more interior trim panels, an acoustic panel, an electrical harness, an electrical module, etc. Accordingly, the attachment portion 48 is used to attach the device 82 to the sheet metal substrate 40 and/or the structural member 78.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A flow drill screw comprising:
a shank extending along a rotation axis and including a flow drill portion disposed at a first axial end of the shank, and a thread portion adjacent the flow drill portion;
a head attached to the shank adjacent the thread portion; and
an attachment portion extending from the head and away from the thread portion, along the rotation axis, wherein the attachment portion is operable to attach a device thereto.

2. The flow drill screw as set forth in claim 1 wherein the head includes an exterior surface disposed radially about the rotation axis, and wherein the exterior surface of the head defines an external drive interface.

3. The flow drill screw as set forth in claim 2 wherein the external drive interface includes a hexagonal drive.

4. The flow drill screw as set forth in claim 2 wherein the exterior surface of the head defines a minimum head width measured perpendicular to the rotation axis, and the attachment portion defines a maximum connector width measured perpendicular to the rotation axis, and wherein the maximum connector width is less than the minimum head width.

5. The flow drill screw as set forth in claim 1 wherein the attachment portion includes a T-stud having a shaft portion attached to and extending from the head, and a connector portion attached to a distal end of the shaft and axially spaced from the head along the rotation axis to define a maximum separation distance.

6. The flow drill screw as set forth in claim 5 wherein the connector portion defines the maximum connector width, and wherein the shaft defines a shaft diameter that is less than the maximum connector width.

7. The flow drill screw as set forth in claim 1 wherein the flow drill portion includes a conical tip operable to form a hole in a sheet metal substrate when pressed against the sheet metal substrate at a high rotational speed and at a high pressure.

8. The flow drill screw as set forth in claim 1 wherein the shank, the head, and the attachment portion are integrally formed together as a single component.

9. An assembly system comprising:
a flow drill screw including:
a shank extending along a rotation axis and including a flow drill portion disposed at a first axial end of the shank, and a thread portion disposed at a second axial end of the shank;
a head attached to the shank at the second axial end of the shank, adjacent the thread portion; and
an attachment portion extending from the head and away from the thread portion, along the rotation axis, wherein the attachment portion is operable to attach a device thereto;
wherein the head includes an exterior surface disposed radially about the rotation axis, and defining an external drive interface;
a drive tool axially moveable along the rotation axis relative to the flow drill screw, and including a radially inner surface disposed radially about the rotation axis and defining an internal drive interface corresponding to and disposed in mating engagement with the external drive interface of the head for transmitting a torque therebetween.

10. The assembly system as set forth in claim 9 wherein the external drive interface of the head and the internal drive interface of the drive tool include a hexagonal drive.

11. The assembly system as set forth in claim 9 wherein the exterior surface of the head defines a minimum head width measured perpendicular to the rotation axis, and the attachment portion defines a maximum connector width measured perpendicular to the rotation axis, and wherein the maximum connector width is less than the minimum head width.

12. The assembly system as set forth in claim 11 wherein the radially inner surface of the drive tool defines a minimum inner tool width measured perpendicular to the rotation axis, and wherein the minimum inner tool width is greater than the maximum connector width and the minimum head width.

13. The assembly system as set forth in claim 9 wherein the drive tool includes a distal end and an open interior region extending along the rotation axis from the distal end a depth for receiving the attachment portion therein.

14. The assembly system as set forth in claim 13 wherein the attachment portion includes a T-stud having a shaft portion attached to and extending from the head, and a connector portion attached to a distal end of the shaft and axially spaced from the head along the rotation axis to define a maximum separation distance, and wherein the depth of the interior region is greater than the maximum separation distance.

15. The assembly system as set forth in claim 14 wherein the connector portion defines the maximum connector width, and wherein the shaft defines a shaft diameter that is less than the maximum connector width.

16. The assembly system as set forth in claim 9 wherein the flow drill portion includes a conical tip operable to form a hole in a sheet metal substrate when pressed against the sheet metal substrate at a high rotational speed and at a high pressure.

17. A vehicle comprising:
a structural member;
a flow drill screw attached to the structural member, wherein the flow drill screw includes:
a shank extending along a rotation axis and including a flow drill portion disposed at a first axial end of the shank, and a thread portion disposed at a second axial end of the shank and in threaded engagement with the structural member;
a head attached to the shank at the second axial end of the shank, adjacent the thread portion; and
an attachment portion extending from the head and away from the thread portion, along the rotation axis; and
a device attached to the attachment portion such that the flow drill screw attaches the device to the structural member.

18. The vehicle as set forth in claim 17 wherein the head includes an exterior surface disposed radially about the rotation axis, and wherein the exterior surface of the head defines an external drive interface.

19. The vehicle as set forth in claim 18 wherein the exterior surface of the head defines a minimum head width measured perpendicular to the rotation axis, and the attachment portion defines a maximum connector width measured perpendicular to the rotation axis, and wherein the maximum connector width is less than the minimum head width.

20. The vehicle as set forth in claim 19 wherein the shank, the head, and the attachment portion of the flow drill screw are integrally formed together as a single component.
